(19) United States
(12) Patent Application Publication
(10) Pub. No.: US 2012/0055155 A1
(43) Pub. Date: Mar. 8, 2012

(54) INTERNAL COMBUSTION ENGINE

(75) Inventors: Ralf Christmann, Kaiserslautern (DE); Rolf Sauerstein, Finkenbach (DE); Christian Haibt, Alsbach-Haehnlein (DE)

(73) Assignee: BORGWARNER INC., Auburn Hills, MI (US)

(21) Appl. No.: 13/320,280

(22) PCT Filed: May 13, 2010
(86) PCT No.: PCT/US10/34636

§ 371 Date: Nov. 14, 2011

(30) Foreign Application Priority Data
May 18, 2009 (DE) 102009021747.9

(51) Int. Cl. F02B 37/18

(52) U.S. Cl. 60/605.1

(57) ABSTRACT

The invention relates to a wastegate (7) which is arranged externally with respect to the turbine housing on exhaust manifolds (3) integrated in the cylinder head (2). The internal combustion engine (1) comprises a cylinder head (2) which is provided with an integrated exhaust manifold (3); a turbocharger (4) which has a turbine (5) with a turbine housing (6); and a wastegate (7) which is arranged separately from the turbine housing (6).

The invention relates to an internal combustion engine according to the preamble of claim 1.

In supercharged internal combustion engines which use an exhaust-gas turbocharger, the latter is often provided with a wastegate. In known turbochargers, the wastegate is integrated in the turbine housing, as described for example in EP 1 256 703 A2.

If the engine is connected to a catalytic converter, the integration of the wastegate into the turbine housing often results in problems with regard to optimally conducting to the catalytic converter the exhaust-gas flow which is diverted past the turbine.

It is therefore an object of the present invention to provide an internal combustion engine of the type specified in the preamble of claim 1 which enables an optimization of the diversion of the wastegate exhaust-gas flow past the turbine.

Said object is achieved by means of the features of claim 1.

The subclaims relate to advantageous refinements of the invention.

According to the invention, the wastegate is formed as a separate structural unit which is provided on the internal combustion engine separately from the turbine housing. Said structural unit comprises a flap seat which is flow-connected to the exhaust manifold and which can be opened and closed by means of a wastegate flap. For this purpose, the wastegate flap is provided with a suitable actuator (for example pneumatic or electric actuator).

According to the invention, the wastegate may either be flange-mounted directly on the cylinder head at the outside or integrated in the cylinder head.

In particular if the internal combustion engine is provided with a catalytic converter, the attachment of the wastegate separately from the turbine housing permits an optimization of the diversion of the wastegate exhaust-gas flow past the turbine, such that said diverted exhaust-gas flow can be supplied preferably centrally to the catalytic converter.

Further details, advantages and features of the present invention emerge from the following description of exemplary embodiments on the basis of the drawing, in which:

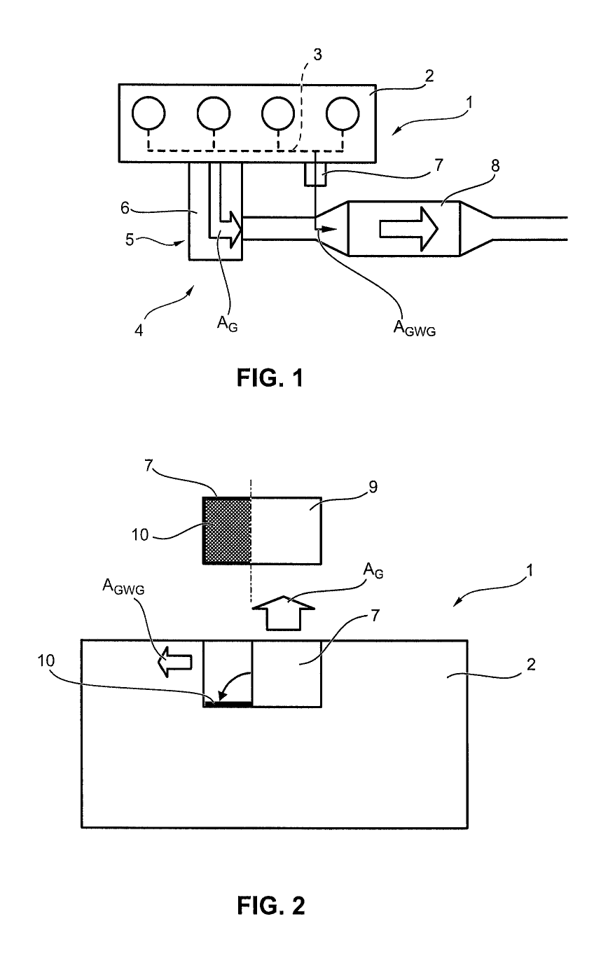

FIG. 1 shows a schematically highly simplified plan view of a first embodiment of an internal combustion engine according to the invention, symbolized only by its cylinder head, and

FIG. 2 shows an illustration, corresponding to FIG. 1, of a second embodiment of the internal combustion engine according to the invention.

The internal combustion engine 1 illustrated in schematically highly simplified form in FIGS. 1 and 2 may be either a diesel engine or a spark-ignition engine. The internal combustion engine 1 is symbolized both in FIG. 1 and in FIG. 2 only by its cylinder head 2, but self-evidently also has all the other components of conventional internal combustion engines. The description thereof is however not required for the explanation of the principles according to the invention, and has accordingly been omitted.

The internal combustion engine 1 illustrated in FIG. 1 has a turbocharger 4 and wastegate 7 in addition to the cylinder head 2. Also provided is an exhaust manifold 3 which is integrated in the cylinder head 2. The turbocharger 4 has a turbine 5 with a turbine housing 6, which symbolize the turbocharger 4 (not illustrated in its entirety).

According to the invention, the wastegate 7 is arranged on the outside of the cylinder head 2 separately from the turbine housing 6, for which purpose said wastegate 7 is flange-mounted directly on the cylinder head 2.

According to FIG. 2, in a second embodiment, the wastegate 7 is integrated in the cylinder head 2.

In both cases, the wastegate exhaust-gas flow A_{GWG} past the turbine can be supplied centrally to the catalytic converter 8 by means of suitable line guidance. If the wastegate 7 is closed, the exhaust-gas flow A_{G} is discharged to the exhaust system or catalytic converter 8 through the turbine.

To complement the above disclosure, reference is explicitly made to the diagrammatic illustration in FIGS. 1 and 2 of the invention.

### LIST OF REFERENCE NUMERALS

1 Internal combustion engine

2 Cylinder head

3 Exhaust manifold

4 Turbocharger

5 Turbine

6 Turbine housing

7 Wastegate

8 Catalytic converter

9 Turbine inlet flange

10 Wastegate flap

1. An internal combustion engine (1)
having a cylinder head (2) which is provided with an integrated exhaust manifold (3);
having a turbocharger (4) which has a turbine (5) with a turbine housing (6); and
having a wastegate (7), wherein
the wastegate (7) is provided separately from the turbine housing (6).

2. The internal combustion engine (1) as claimed in claim 1, wherein the wastegate (7) is flange-mounted directly on the cylinder head (2) at the outside.

3. The internal combustion engine (1) as claimed in claim 1, wherein the wastegate (7) is integrated in the cylinder head (2).

4. An internal combustion engine (1)
having a cylinder head (2) which is provided with an integrated exhaust manifold (3);
having a turbocharger (4) which has a turbine (5) with a turbine housing (6); and
having a wastegate (7), wherein
the wastegate (7) is provided separately from the turbine housing (6), and
a catalytic converter is provided in the exhaust stream downstream of the wastegate.
